(19) United States
(12) Patent Application Publication
(10) Pub. No.: US 2026/0042615 A1
(43) Pub. Date: Feb. 12, 2026

(54) APPARATUS AND METHOD FOR CENTRING COMPONENTS

(71) Applicant: G.D S.P.A., Bologna (BO) (IT)

(72) Inventors: Paolo DEGLIESPOSTI, Bologna (BO) (IT); Fabio GAUDENZI, Bologna (BO) (IT); Daniele GROSSO, Bologna (BO) (IT); Luca TESTONI, Bologna (BO) (IT)

(21) Appl. No.: 18/998,715

(22) PCT Filed: Jul. 25, 2023
(86) PCT No.: PCT/IB2023/057521

§ 371 Date: Jan. 27, 2025

(30) Foreign Application Priority Data
Jul. 27, 2022 (IT) 102022000015792

(51) Int. Cl. B65G 47/28

(52) U.S. Cl. CPC B65G 47/28; B65G 2201/02

(57) ABSTRACT

Described is a centring apparatus, including a conveyor for feeding articles configured for feeding a succession of components, a centring station, positioned downstream of the feeding conveyor and including centring means configured for receiving the components from the feeding conveyor and for centring the components in accordance with a predetermined positioning and/or orientation and a release area, positioned downstream of the centring station for receiving the centred components, coming from the centring station. The apparatus also includes movement means designed to transport the at least one component along a centring path extending from the feeding conveyor to the release area through the centring station.

### TECHNICAL FIELD

The invention applies to the industrial manufacturing sector and relates to a centring apparatus and a method for centring components.

The term “components” means generic articles intended to be processed and/or assembled with at least one further component for making a product.

In the sector relevant to this invention, in the steps for feeding components intended for a precision assembly or processing, there is the problem of determining the correct positioning and/or orientation of the components on the feeding conveyor so that they can be picked up accurately by respective gripping means and transferred to a release area, where they will subsequently be processed and/or assembled.

### BACKGROUND ART

The use is known of conveyor trays or belts having a plurality of housing seats designed to house the above-mentioned components. The Applicant has noted that the use of these conveyor trays or belts, even though they are well established and economical, has the drawback of resulting in an approximate positioning of the components inside the respective housing seats, which are typically oversized with respect to the components. It follows that the pick-up units grip the components in a position and/or with an orientation which cannot be precisely determined and is therefore unsuitable for the subsequent process steps (in particular, processing and/or assembly), giving rise to process errors and a not insignificant number of rejected products.

In order to overcome these drawbacks, the use is known of optical control systems which indicate to the picking up device the real positioning and/or the real orientation of the component inside the housing seat so that the picking up device, by feedback, can optimise the picking up. However, these control systems cause a considerable complication in the systems and a considerable increase in the relative costs.

### AIM OF THE INVENTION

In this context, the technical purpose which forms the basis of this invention is to provide a centring apparatus as well as a method for centring components that overcomes the above-mentioned drawbacks of the prior art. In particular, the aim of the invention is to provide a centring apparatus as well as a method for centring components which allows a high level of process reliability and, simultaneously, a considerable simplification in terms of process and structure.

The technical purpose indicated and the aim specified are substantially achieved by a centring apparatus as well as a method for centring components with the technical features described in claims 1 and 16 and/or in one or more of the claims dependent thereon.

### BRIEF DESCRIPTION OF THE DRAWINGS

Further features and advantages of the invention are more apparent in the non-limiting description which follows of a preferred non-limiting embodiment of a centring apparatus and a method for centring components illustrated in the accompanying drawings, in which:

FIG. 1 is a schematic view of a first embodiment (by way of a non-limiting example) of a centring apparatus according to the invention;

FIG. 2 is a schematic view of a detail of the embodiment of the apparatus of FIG. 1;

FIG. 3 is a schematic view of a further detail of the embodiment of the apparatus of FIG. 1;

FIGS. 4A-4B are schematic views of the detail of FIG. 4 in two separate operating steps;

FIG. 5 is a schematic view of a further detail of the embodiment of the apparatus of FIG. 1.

### DETAILED DESCRIPTION OF PREFERRED EMBODIMENTS OF THE INVENTION

With reference to the accompanying drawings, the numeral “1” denotes in its entirety centring apparatus according to the invention.

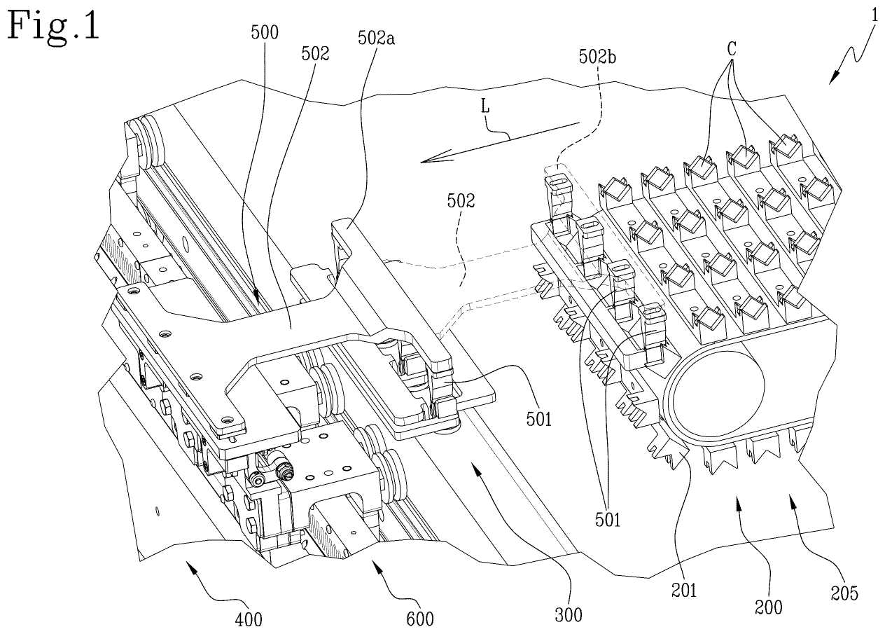

As shown in FIG. 1, in accordance with the invention, the apparatus 1 comprises a conveyor 200 for feeding articles configured for feeding a succession of components “C”. The feeding conveyor 200 has at least one containment seat 201 designed to house a respective component “C” so that the feeding conveyor 200 is suitable for conveying during feeding at least one component “C”.

Preferably, the feeding conveyor 200 has a plurality of containing seats 201, arranged in one or more rows, in such a way that the feeding conveyor 200 is suitable for simultaneously conveying a succession of groups of components “C”.

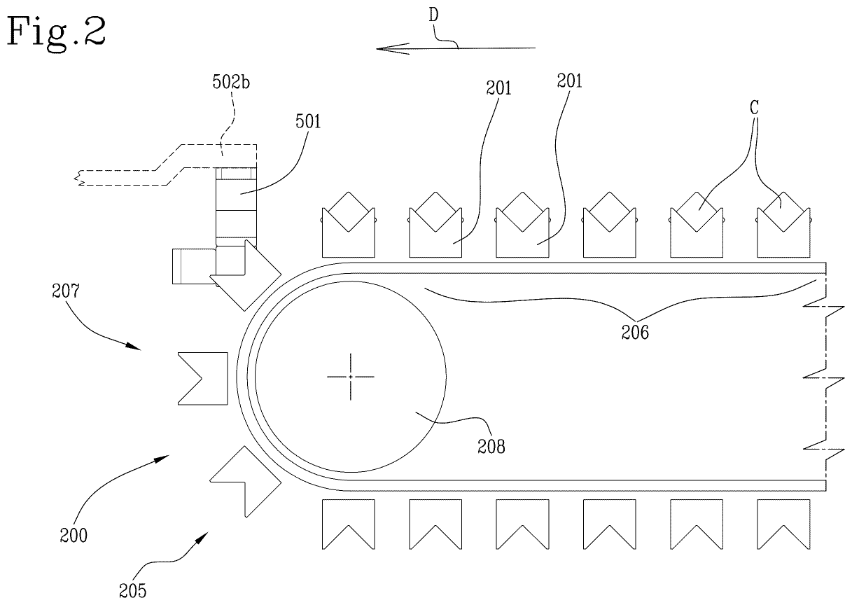

Preferably, the feeding conveyor 200 comprises a conveying belt or chain 205, illustrated by way of example in FIGS. 1 and 2, movable along a respective advancement direction “D” comprising a main straight and/or horizontal conveying stretch 206. The conveyor belt 205 has receiving zones for supporting the respective components “C”, for example designed to retain the components by gravity (provided with a concave shape and/or one or more engaging portions facing upwards). In other words, the containment seats 201 are formed by the above-mentioned receiving zones.

As shown in FIGS. 1 and 2, the apparatus 1 also comprises movement means 500 configured for picking up at least one component “C” from the feeding conveyor 200 and transferring it to a centring station 300, positioned downstream of the feeding conveyor 200 relative to a centring path “L”.

Preferably, the movement means 500 are configured for simultaneously picking up a group (row) of components “C” from the feeding conveyor 200 and transferring it to the centring station 300. For this purpose, the movement means 500 comprise a plurality of gripping members 501 positioned in one or more rows.

According to an aspect of the invention, as shown in detail in FIG. 2, the movement means 500 are configured for picking up the one or more components “C” in an angled position 207 of the conveyor belt 205. In particular, the angled position 207 is positioned downstream of the main conveying stretch 206 and defines a lying of the component “C” which is different from the lying defined by the main conveying stretch 206. In particular, the angled position 207 is defined by a portion of the belt or chain trained around a return pulley 208. Advantageously, this feature allows the gripping members 501 to pick up the one or more components “C” with a predetermined orientation, different from the orientation adopted on the main stretch 206, in such a way as to actuate a pre-positioning and/or a pre-orientation of the components “C”, thus simplifying the subsequent centring steps.

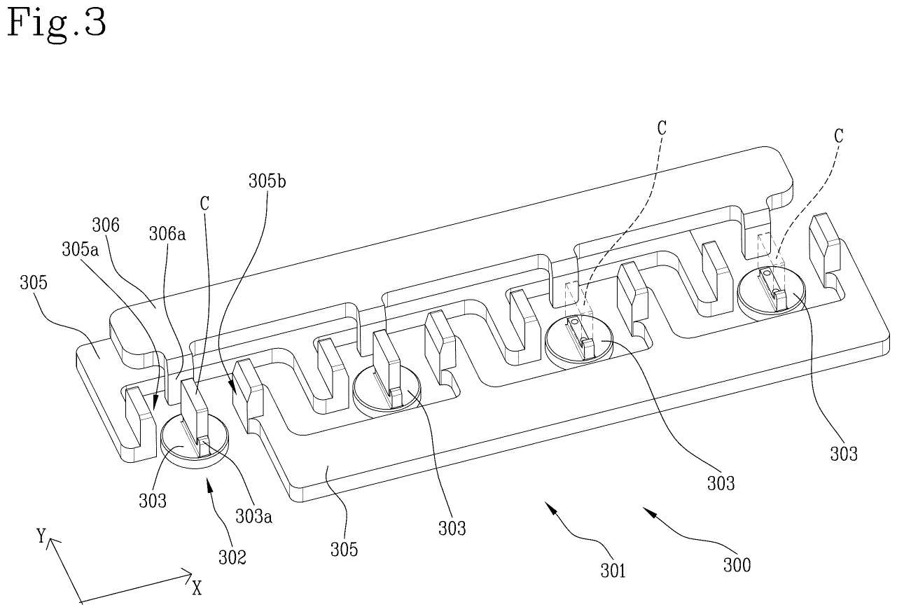

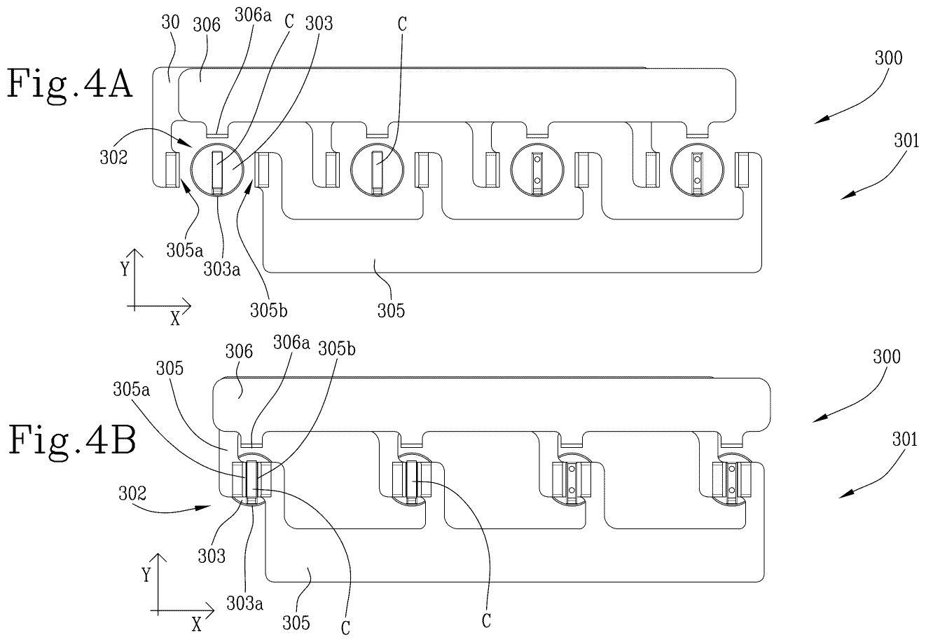

As shown in FIGS. 3 and 4A-4B, the centring station 300 comprises centring means 301 configured for receiving the one or more components “C” from the feeding conveyor 200 and performing a centring of the components “C” according to a predetermined positioning and/or orientation.

In this description, the term “centring” is used to denote an operation which consists in determining a desired and predetermined positioning and/or orientation of the component “C”, according to a preset level of precision.

Preferably, the centring means 301 are configured to perform a translation of each component “C” on a centring plane “XY”. Preferably, the centring plane “XY” is horizontal.

This also includes centring obtained by translating along a simple centring line.

In other words, the component “C” is positioned according to a predetermined positioning, in particular by movement on the centring plane “XY”, using the centring means 301 whilst the component “C” is positioned in the centring station 300.

According to an aspect of the invention, the centring station 300 comprises at least one receiving station 302, comprising a respective support 303 for supporting a respective component “C” to be subjected to centring. The support 303 is configured in such a way as to have a predetermined clearance relative to the component “C” along at least one direction in such a way as to allow a centring movement of the component “C” relative to the support 303. For example, the support 303 has a supporting surface 304 defining the above-mentioned centring surface “XY” and on which the component “C” is slidably positioned, in particular simply resting. For this reason, at a functional level, the movement means 500 transfer the component “C” to the centring station 300 positioning it resting on the respective support 303 of the centring station 300.

From the structural point of view, the support 303 could be made in various ways. For example, it might have a cavity designed to house at least a lower portion of the component “C” and/or a protrusion suitable for insertion in a lower cavity of the component “C”, allowing the above-mentioned clearance, or alternatively a simple supporting surface without definition of penetration between the support 303 and the component “C”.

Preferably, the centring station 300 comprises a plurality of receiving stations 302 positioned according to one or more rows, wherein each receiving station 302 comprises a respective support 303 for supporting the respective component “C” to be subjected to centring.

Preferably, moreover, each support 303 is stationary relative to the relative receiving station 302, that is to say, located in a stable position.

FIGS. 3 and 4A-4B show a preferred, non-limiting example embodiment of the centring means 301.

At a functional level, the step of positioning the component “C” according to the predetermined positioning is performed (downstream of the resting of the component “C” on the support 303) by translating the component “C” along at least a first direction “X” until reaching the predetermined positioning.

For this purpose, as shown in the drawings, the centring means 301 comprise at least first centring means 305 configured for making a movement of each component “C” relative to the respective support 303 along the first direction “X” whilst the component “C” is supported by the support 303. In other words, the first centring means 305 are configured for moving the respective component “C” on the centring plane “XY” along the first direction “X”.

Preferably, the first centring means 305 comprise, for each receiving station 302, at least a first engagement surface 305a configured to operatively abut against the at least one component “C” during an operative centring step in such a way as to apply a pushing action on the component “C” along the first direction “X”.

Preferably, the first centring means 305 comprise a plurality of first engagement surfaces 305a configured to act simultaneously on a group of components “C”. For this purpose, the first engagement surfaces 305a of the first centring means 305 are defined by a same centring unit. In particular, the first centring means 305 may comprise a monolithic body, for example plate-shaped and/or configured like a comb, defining the first engagement surfaces 305a so as to simultaneously centre a group of components “C”.

The first centring means 305 also comprise, for each receiving station 302, a second engagement surface 305b facing and/or opposite the first engagement surface 305a and configured to operatively abut against the at least one component “C” during an operative centring step in such a way as to exert a pushing action on the component “C” along the first direction “X”, in the opposite direction relative to the first engagement surface 305a.

In other words, during the operative centring step, the component “C” is interposed between the first engagement surface 305a and the second engagement surface 305b of the first centring means 305 which enter into contact and push along the first direction “X” the component “C” in opposite directions.

Preferably, the first centring means 305 comprise a plurality of second engagement surfaces 305b configured to act simultaneously on a group of components “C”. For this purpose, the second engagement surfaces 305b of the first centring means 305 are defined by a same centring unit. In particular, the first centring means 305 may comprise a further monolithic body, for example plate-shaped and/or configured like a comb, defining the second engagement surfaces 305b so as to simultaneously centre a group of components “C”.

According to an aspect of the invention, the first engagement surface 305a or the first engagement surfaces 305a can be moved independently from the second engagement surface 305b or from the second engagement surfaces 305b. For this purpose, the centring unit of the first engagement surfaces 305a and the centring unit of the second engagement surfaces 305b are separate from each other and can be actuated independently from each other (FIGS. 4A and 4B). Advantageously, the independent movement makes it possible to perform a two-way centring, for example simultaneous, along the first direction “X”, quickly obtaining the desired positioning along the first direction “X”.

Alternatively to the one or more second engagement surfaces 305b of the first centring means 305, according to an embodiment not illustrated in the accompanying drawings, the support 303 may have a stop surface, in particular a protrusion, defining an abutment for the corresponding component “C” during a pushing action exerted by the first engagement surface 305a. In other words, at a functional level, the first engagement surface 305a of the first centring means 305 engages the component “C” and moves it towards the respective stop surface of the support 303 so as to abut it and align it with the stop surface. This allows the use of the second engagement surfaces 305b and therefore of the corresponding centring unit to be dispensed with.

According to an aspect of the invention, the step of positioning the component “C” in accordance with the predetermined positioning may be performed by translating the component “C” along the first direction “X” and a second direction “Y”, transversal and preferably perpendicular to the first direction “X”. For this purpose, as shown in FIGS. 3, 4A-4B, the centring means 301 also comprise second centring means 306 configured for making a movement of each component “C” relative to the respective support 303 along the second direction “Y”, transversal and preferably perpendicular to the first direction “X”, whilst the component “C” is supported by the support 303. In other words, at a functional level, the step of positioning the component “C” according to the predetermined positioning is performed by translating the component “C” along the first direction “X” and the second direction “Y”, transversal or perpendicular to each other.

The movement along the first direction “X” and the second direction “Y” may occur either simultaneously or in successive steps.

FIG. 4A shows a step of disengaging first centring means 305 and second centring means 306.

FIG. 4B shows a step of engaging first centring means 305 but not second centring means 306.

Preferably, the first centring means 306 comprise, for each receiving station 302, at least a first engagement surface 306a configured to operatively abut against the at least one component “C” during an operative centring step in such a way as to apply a pushing action on the component “C” along the second direction “X”.

Preferably, the second centring means 306 comprise a plurality of first engagement surfaces 306a configured for acting simultaneously on a group of components “C”. For this purpose, the first engagement surfaces 306a of the second centring means 306 are defined by a same centring unit. In particular, the second centring means 306 may comprise a monolithic body, for example plate-shaped and/or configured like a comb, to which are fixed or integrated the first engagement surfaces 306a so as to simultaneously centre a group of components “C”.

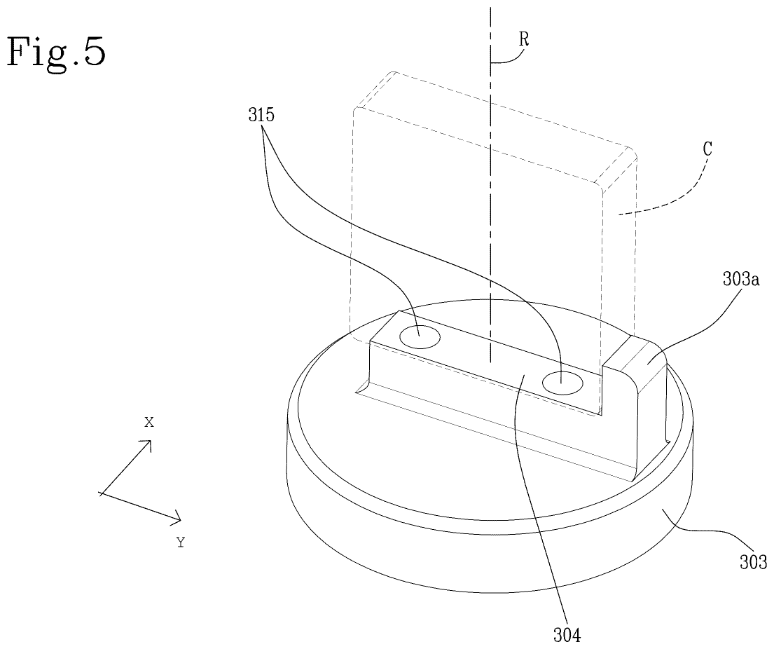

As shown in FIG. 5, the support 303 has a stop surface 303a, in particular a protrusion, defining an abutment for the corresponding component “C” during a pushing action exerted by the first engagement surface 306a of the second centring means 306. In other words, at a functional level, the first engagement surface 306a of the second centring means 306 engages the component “C” and moves it towards the respective stop surface 303a of the support 303 so as to abut it and align it with the stop surface 303a.

Alternatively to the stop surface 303a of the support 303, according to an embodiment not illustrated in the accompanying drawings, the second centring means 306 may comprise, for each receiving station 302, a second engagement surface facing and/or opposite the first engagement surface 306a of the second centring means 306 and configured to operatively abut against the at least one component “C” during an operative centring step in such a way as to exert a pushing action on the component “C” along the second direction “Y”, in the opposite direction relative to the first engagement surface 306a. In other words, during the operative centring step, the component “C” would be interposed between the first engagement surface 306a and the second engagement surface of the second centring means 306 which enter into contact and push along the first direction “Y” the component “C” in opposite directions. In that case, the first engagement surface 306a and the second engagement surface may be moved independently from each other. Moreover, again according to this solution, the second engagement surfaces of the second centring means 306 could be defined by a same centring unit; in particular a further monolithic body, for example plate-shaped and/or configured like a comb, defining the second engagement surfaces so as to simultaneously centre a group of components “C”. The centring unit of the first engagement surfaces 306a and the centring unit of the second engagement surfaces would be, also in this case, which are separate from each other and can be actuated independently from each other.

According to a further embodiment not illustrated in the accompanying drawings, the first centring means 305 have only first engagement surfaces whilst the second centring means 306 have only first engagement surfaces. According to this embodiment, therefore, the support 303 has a pair of stop surfaces which are transversal to each other, preferably perpendicular, for example integral or adjacent to each other.

According to an aspect of the invention, as shown in detail in FIG. 5, each support 303 may comprise retaining means 315, preferably of the pneumatic suction type, for stably retaining the respective component “C”. Preferably, the pneumatic suction is activated after the centring of the component “C” in such a way as to stabilise it in the predetermined positioning and/or orientation, and is deactivated during the picking up of the components “C” from the centring station 300 by respective movement means 500. Preferably, the retaining means 315 are defined by one or more suction openings lying on a supporting surface parallel to the above-mentioned centring plane “XY”.

In accordance with an aspect of the invention, each component “C” may be made to rotate about a respective axis of rotation, preferably stationary and in particular perpendicular to the centring plane “XY”. Advantageously, this technical feature makes it possible to orient the respective component “C” according to a predetermined orientation, preferably after centring it, so as to be able to be picked up by the movement means 500 according to an orientation different from the infeed orientation to the centring station 300.

For this purpose, each support 303 may be mounted rotatably in the respective receiving station 302 so as to be rotatable about a respective axis of rotation “R”, preferably stationary, in particular perpendicular to the centring plane “XY”.

Alternatively, the rotation of the component “C” may be performed during the movement of the component “C” from the feeding conveyor 200 to the assembly station 300, in particular from the movement means 500, or downstream of the centring station 300.

Following the centring, the at least one component “C” centred is transferred from the centring station 300 to a release area 400 positioned downstream of the centring station 300 relative to the above-mentioned centring path “L”. For this purpose, the apparatus 1 preferably uses the same movement means 500 also for picking up the at least one component “C” centred by the centring station 300 and transferring it to the release area 400.

In this description, the expression “release area” may mean an assembly station, configured for assembling the centred components “C”, coming from the centring station 300, with at least one additional component or may mean a station for processing the centred components “C” (for example, a marking station and/or a printing station of the components “C”).

Alternatively, the release area 400 is interposed between the centring station 300 and the assembly or processing station (not illustrated). According to this solution, the movement means 500 may comprise a transfer conveyor 600 positioned at (or downstream of) the release area 400 and configured for transferring, individually or in groups, the centred components “C” from the release area 400 to the station for assembling or processing the components “C”. Preferably, the transfer conveyor 600 comprises a line with independent carriages (XTS).

According to an aspect of the invention, the movement means 500 may comprise a gripping head 502, movable between the feeding conveyor 200 and the centring station 300 and between the centring station 300 and the release area 400 of the centred components “C”.

According to the preferred embodiment illustrated, the gripper head 502 has two gripping regions 502a, 502b each provided with at least one gripping member 501 for at least one respective component “C”, and in particular at least one row of gripping members 501. The gripper head 502 is configured for transferring at least a first centred component “C” from the centring station 300 to the release area 400 by means of the at least one gripping member 501 of the first gripping region 502a (FIG. 1) and simultaneously for transferring at least a second component “C” from the feeding station 200 to the centring station 300 by means of the at least one gripping member 501 of the second gripping region 502b (FIGS. 1 and 2).

In other words, the step of transferring the at least one component “C” from the feeding conveyor 200 to the centring station 300 and the step of transferring the component “C” centred from the centring station 300 to the release area 400 are actuated simultaneously on different components “C” and preferably by means of a same gripper head 502.

Preferably, as shown in FIG. 1, the first and the second gripping regions 502a, 502b comprise a plurality of gripping members 501 so that the gripper head 502 is configured for transferring a first group of components “C” from the centring station 300 to the release area 400 by means of a first array of gripping members 501 of the first gripping region 502a and simultaneously for transferring a second group of components “C” from the feeding station 200 to the centring station 300 by means of a second array of gripping members 501 of the second gripping region 502b.

Still more preferably, the first gripping region 502a and the second gripping region 502b have an equal number of gripping members 501 so that the first group of components “C” and the second group of components “C” have the same number of components “C”.

Preferably, the gripping members 501 are integrally connected to the gripper head 502 and spaced according to a predetermined order. Preferably, the first row of gripping members 501 and the second row of gripping members 501 are operatively positioned in such a way as to follow the distribution of the receiving stations 302 of the centring station 300. However, the first row of gripping members 501 and the second row of gripping members 501 are operatively positioned in such a way as to follow the distribution of the containing seats 201 of the feeding conveyor 200.

The invention achieves the above-mentioned aims, eliminating the drawbacks highlighted in the prior art: in this regard, it should be noted firstly that the centring apparatus 1 and the method for centring components as described and/or claimed allow a high level of process reliability and, simultaneously, a considerable simplification in terms of process and structure.

This result is achieved in particular thanks to the centring station which guarantees an optimum and precise positioning and/or orientation of the components “C”. Advantageously, in this way, errors and waste are considerably reduced in the subsequent steps of transferring, assembling and/or processing components whilst at the same time maintaining a simplified and inexpensive system structure.

It should also be noted that this result is achieved, secondly, by the accessory rotations of the components performed in the centring station or in the transfers either side of it, which increase the structural compactness of the apparatus.

1. A centring apparatus, comprising:
an article feeding conveyor configured for feeding a succession of components and having at least one containing seat adapted to accommodate a respective component;
a centring station, disposed downstream of the feeding conveyor and comprising centring means configured for receiving the components from the feeding conveyor and centring the components according to a predetermined position and/or orientation;
a releasing area, located downstream of the centring station to receive the centred components from the centring station;
movement means, adapted to transport the at least one component along a centring path extending from the feeding conveyor to the releasing area through the centring station.

2. The apparatus according to claim 1, wherein the centring means are configured to move the at least one component in translation in a centring plane, preferably horizontal.

3. The apparatus according to claim 1, wherein the centring station comprises one or more receiving positions, preferably arranged in one or more rows, and wherein each receiving position comprises a respective support, preferably stationary, for supporting a respective component to be centred, the centring means comprising at least first centring means configured to displace each component relative to the respective support along a first axis while the component is being supported by the support.

4. The apparatus according to claim 3, wherein the first centring means comprise, for each receiving position, at least a first engagement surface configured to operatively butt against the at least one component during an operative centring step so as to apply a pushing action on the component along the first axis.

5. The apparatus according to claim 4, wherein the first centring means also comprise, for each receiving position, a second engagement surface facing and/or contraposed with the first engagement surface and configured to operatively butt against the at least one component during an operative centring step so as to apply a pushing action on the component along the first axis in the opposite direction relative to the first engagement surface, the first engagement surface and the second engagement surface being preferably movable independently of each other.

6. The apparatus according to claim 3, wherein the centring means further comprise second centring means configured to displace each component relative to the respective support along a second axis, transversal and preferably perpendicular to the first axis while the component is being supported by the support.

7. The apparatus according to claim 6, wherein the second centring means comprise, for each receiving position, at least a first engagement surface configured to operatively butt against the at least one component during an operative centring step so as to apply a pushing action on the component along the second axis.

8. The apparatus according to claim 7, wherein the second centring means also comprise, for each receiving position, a second engagement surface facing and/or contraposed with the first engagement surface and configured to operatively butt against the at least one component during an operative centring step so as to apply a pushing action on the component along the second axis in the opposite direction relative to the first engagement surface, the first engagement surface and the second engagement surface being preferably movable independently of each other.

9. The apparatus according to claim 4, wherein the support has a stop surface, in particular a protrusion, defining an abutment for stopping the corresponding component while the pushing action is being applied thereon by the first engagement surface.

10. The apparatus according to claim 3, wherein the centring station comprises one or more receiving positions and wherein the first engagement surfaces of the first centring means are defined by the same centring member and/or the second engagement surfaces of the first centring means are defined by the same centring member and/or the first engagement surfaces of the second centring means are defined by the same centring member and/or the second engagement surfaces of the second centring means are defined by the same centring member, the centring members being separate from each other and drivable independently of each other, each centring member being preferably configured like a comb.

11. The apparatus according to claim 3, wherein the support, or each support, is rotatable about a respective axis of rotation, preferably stationary, in particular perpendicular to the centring plane.

12. The apparatus according to claim 3, wherein the support comprises retaining means, preferably of a pneumatic suction type, to securely retain the respective component.

13. The apparatus according to claim 1, wherein the movement means comprise a gripping head, movable between the feeding conveyor and the centring station and between the centring station and the releasing area for releasing the centred components, wherein the gripping head has two gripping regions, each provided with at least one gripping member for at least one respective component, and is configured for transferring at least a first component from the centring station to the releasing area by means of at least one gripping member of the first gripping region and simultaneously transferring at least a second component from the feeding station to the centring station by means of the at least one gripping member of the second gripping region.

14. The apparatus according to claim 1, wherein:
the releasing area coincides with an assembly station, for assembling the component to another component, or with a processing station for processing the component;
or wherein the movement means also comprise a transfer conveyor located at the releasing area and configured for transferring the centred components, individually or in groups, from the releasing area to an assembly station, for assembling the component to another component, or to a processing station for processing the component, the transfer conveyor preferably comprising a line of independent carriages.

15. The apparatus according to claim 1, wherein the feeding conveyor comprises a conveyor belt or chain movable along a respective feed direction comprising a main, rectilinear and/or horizontal conveying stretch, wherein the conveyor belt has receiving zones for supporting respective components, and wherein the movement means are configured to pick up the at least one component at an angled position of the conveyor belt, the angled position being downstream of the main conveying stretch and defining, for the component, a positioning plane different from the positioning plane defined by the main conveying stretch, the angled position being, in particular, defined by a portion of the belt or chain wound around a return pulley.

16. A method for centring components, comprising the following steps:
feeding at least one component by means of a feeding conveyor;
transferring the at least one component from the feeding conveyor to a centring station;
positioning the component at a predetermined position, in particular by moving it in a centring plane, preferably horizontal, using centring means, while the component is located in the centring station;
transferring the centred component from the centring station to a releasing area.

17. The method according to claim 16, wherein the step of transferring the component to the centring station is carried out by positioning the component on a respective support of the centring station and wherein the step of positioning the component at a predetermined position is carried out by moving the component in translation with respect to the respective supports along at least one axis, preferably along two axes that are transversal or perpendicular to each other, until reaching the predetermined position; preferably, the component being retained by pneumatic suction on the respective support.

18. The method according to claim 16, wherein the step of positioning the component at a predetermined position is performed simultaneously on a plurality of components located in the centring station, where they are, in particular, arranged in one or more rows.

19. The method according claim 16, wherein the step of transferring the centred component from the centring station to the assembly station comprises a step of transferring the centred component from the centring station to the releasing area, and wherein the steps of transferring the at least one component from the feeding conveyor to the centring station and transferring the centred component from the centring station to the releasing area are carried out simultaneously on different components and preferably by means of the same gripping head.

20. The method according to claim 17, further comprising a step of rotating the component about an axis preferably perpendicular to the centring plane, the rotation being accomplished by rotating the support or while the component is being moved from the feeding conveyor to the releasing area.
